(19) United States
(12) Patent Application Publication
(10) Pub. No.: US 2023/0202803 A1
(43) Pub. Date: Jun. 29, 2023

(54) ELEVATOR ACCESS DOORS

(71) Applicant: Otis Elevator Company, Farmington, CT (US)

(72) Inventor: Juan Cortes Rodriguez, Vigo Pontevedra (ES)

(21) Appl. No.: 17/848,058

(22) Filed: Jun. 23, 2022

(30) Foreign Application Priority Data
Dec. 23, 2021 (EP) 21383205.8

(51) Int. Cl. B66B 11/02; E05D 3/12

(52) U.S. Cl. CPC B66B 11/0226; E05D 3/122

(57) ABSTRACT

An access door assembly for an elevator car, the access door assembly including: an elevator car panel including an access hatch; an access door panel arranged to close the access hatch; and a hinge mechanism connecting the access door panel to the elevator car panel; the hinge mechanism allows the access door panel to move from an initial closed position in an initial plane to a final open position in a final plane substantially parallel to the initial plane; wherein the initial plane is the plane of the elevator car panel; and the hinge mechanism constrains the access door panel when opening to move perpendicular to the initial plane of the elevator car panel and to rotate around an axis perpendicular to the initial plane of the elevator car panel, to enable the access door panel to reach a final open position.

### FOREIGN PRIORITY

This application claims priority to European Patent Application No. 21383205.8, filed Dec. 23, 2021, and all the benefits accruing therefrom under 35 U.S.C. §119, the contents of which in its entirety are herein incorporated by reference.

### TECHNICAL FIELD

This disclosure relates to an access door panel in an elevator car panel. Access door panels as disclosed herein are suitable for use as an emergency exit from an elevator car.

### BACKGROUND

Access doors for elevator cars may be used by maintenance personnel to access the interior of an elevator car during repair procedures, for example if the main elevator car doors are jammed. An access door in the floor panel of an elevator car may even allow a person trapped in the hoistway pit to escape into the elevator car.

It is known in the art for access doors to be provided in elevator cars to provide safe exit of passengers from the elevator car in case of an emergency. Such access doors are commonly located in the ceilings of elevator cars, where emergency personnel can help passengers to escape in the event of an emergency. Traditional access doors use common door hinges to open or close the access door panels.

Traditional systems provide additional hazards, as when the door is open it can interfere with the space inside the elevator car, or the space on top of the elevator car, where people need to be able to move easily and safely. This can be a particular issue for smaller elevator cars, where there is limited space available on top of the car.

There is therefore a need to provide access doors in elevator cars, which allow more freedom for people using the access door, no matter the size of the elevator car.

### SUMMARY

According to a first aspect of this disclosure there is provided an access door assembly for an elevator car comprising: an elevator car panel comprising an access hatch; an access door panel arranged to close the access hatch; and a hinge mechanism connecting the access door panel to the elevator car panel; wherein the hinge mechanism allows the access door panel to move from an initial closed position in an initial plane to a final open position in a final plane substantially parallel to the initial plane; wherein the initial plane is the plane of the elevator car panel; and wherein the hinge mechanism constrains the access door panel when opening to move perpendicular to the initial plane of the elevator car panel and to rotate around an axis perpendicular to the initial plane of the elevator car panel, to enable the access door panel to reach a final open position in the final plane substantially parallel to the elevator car panel and substantially outside the access hatch.

It will be appreciated that, according to the present disclosure, the access door assembly provides an access door panel capable of opening in a small space. When the access door panel reaches its final open position, it does not interfere with the passage of people through the access hatch, whether the final open position is inside or outside the elevator car. The access door panel is moved to be substantially parallel to the elevator car panel rather than hanging down into the elevator car causing obstruction, or standing up above the car roof and causing a trip hazard. The access door assembly provides an access door panel which is easy for emergency personnel, maintenance personnel, or passengers to open safely as required. By retaining a hinge mechanism, rather than using a removable or sliding access door, the access door panel is still constrained to rotate and gravity can assist with its opening.

The hinge mechanism can be achieved in a number of ways, including a number of independent or cooperating parts arranged to constrain the access door panel when opening to move perpendicular to the initial plane of the elevator car panel and to rotate around an axis perpendicular to the initial plane. In some examples, the movement of the access door panel may be multi-stage movements, i.e. the hinge mechanism first allows for the movement (e.g. only) perpendicular to the initial plane, and then (e.g. only) the rotational movement occurs in a second stage. In some examples, the hinge mechanism allows for a single movement which combines both the perpendicular movement and rotational movement.

The access door assembly may be located anywhere in a suitable elevator door panel, and is particularly suitable for elevator door panels made with a modular design. It is suitable for any size of elevator car, as the hinge mechanism can be oriented to ensure the final open position fits in the footprint of the elevator car panel, e.g. without causing interference with the car frame.

In some examples the hinge mechanism constrains the access door panel when opening to move along a helical path from the initial closed position to the final open position. A helical path can be produced by combining the movements in a single coordinated action produced by the hinge mechanism.

In some examples the hinge mechanism is arranged to convert movement of the access door panel perpendicular to the initial plane of the elevator car panel into rotational movement around the axis perpendicular to the initial plane of the elevator car panel. Such an arrangement may be advantageous as it reduces the manipulation required of the access door panel for it to open. It is desirable to have an access door assembly which provides for a simple and easy opening of the access door panel in case of emergency evacuation of the elevator car.

In some examples the movement of the access door panel is facilitated by the hinge mechanism including one or more mechanical linkages, hydraulic pistons, springs, etc. The hinge mechanism is reliable even in a power outage if it does not rely on electrical power for its operation. However, in some examples the movement is facilitated by the hinge mechanism including one or more electromagnets or electrical actuators.

In some examples the hinge mechanism comprises a mechanical linkage including a first gear mounted to the elevator car panel and a second gear mounted to the access door panel. For example, the arrangement and orientation of the first gear relative to the second gear can ensure that the access door panel is constrained to move perpendicular to the initial plane of the elevator car panel and to rotate around an axis perpendicular to the initial plane of the elevator car panel. The first and second gears may operate independently to move the access door panel (e.g. in stages), or they may cooperate to move the access door panel (e.g. in a single movement).

In some examples the first gear is mounted on a first axle parallel to the elevator car panel, the second gear is mounted on a second axle perpendicular to the access door panel, and the first and second gears intermesh to rotate the access door panel around the axis perpendicular to the initial plane of the elevator car panel when the access door panel is moved perpendicular to the initial plane of the elevator car panel.

In some examples the hinge mechanism constrains the access door panel when opening to also move parallel to the initial plane of the elevator car panel. This may be achieved using a parallelogram arrangement.

In some examples the hinge mechanism comprises: two pairs of axes parallel to one another; an upper cam arm and a lower cam arm which connect the two pairs of axes to form a pivoting parallelogram when looking along the two pairs of axes; and a first gear and a second gear having perpendicular axles; wherein the first gear is mounted on one of the first pair of axes so its axle lies parallel to the initial plane and the second gear is mounted on the access door panel with its axle perpendicular to the access door panel; wherein a perpendicular movement of the access door panel causes movement of the access door panel parallel to the elevator car panel; the combination of the perpendicular and parallel movements cause rotation about the two pairs of axes; and wherein the rotation about the two pairs of axes rotates the first gear intermeshed with the second gear and the access door panel rotates with the second gear. Such an arrangement allows for easy movement of the access door panel from its initial closed position to its final open position. A user only needs to apply a force to the access door panel to initiate the perpendicular movement (e.g. pushing or pulling in a direction perpendicular to the initial plane of the elevator car panel) and then the hinge mechanism carries the access door panel to its final open position in the final plane substantially parallel to the elevator car panel and substantially outside the access hatch.

In addition to this pivoting parallelogram arrangement, the hinge mechanism may be equipped with a hydraulic system to aid movement of the access door panel. In some examples the hinge mechanism includes one or more springs. In some examples the hinge mechanism may be motorized.

In some examples at least two axes of the two pairs of axes are fixed relative to the elevator car panel. Such an arrangement allows for a more rigid hinge mechanism, which is often required when the access door panel is of considerable weight. It is important to take into account the weight of the access door panel as it will greatly affect the ease of movement of the hinge mechanism, and influence the structural elements of the hinge mechanism.

In some examples the hinge mechanism allows the access door panel to rotate by at least 90 degrees around the axis perpendicular to the initial plane of the elevator car panel. Such an arrangement allows the access door panel to move away from the access hatch. In the hinge mechanism a suitable gearing ratio may be required to enable a small perpendicular movement of the access door panel to drive the required rotation.

The hinge mechanism may be adjustable so as to achieve a desired angle through which the access door panel rotates (around the axis perpendicular to the initial plane of the elevator car panel) to reach its final open position. This angle can therefore be adjusted when the assembly is installed to suit the geometry of the elevator car. In some examples the access door assembly further comprises a latch arranged to hold the access door panel in its final open position. This ensures that the access door panel is held open reliably. A magnetic, mechanical or electromechanical latch may be employed.

According to a second aspect an elevator car is provided, wherein the elevator car comprises the access door assembly as disclosed herein.

In some examples the elevator car panel is part of a structural ceiling of the elevator car. What is meant by a structural ceiling is one defined by the roof of the elevator car. In some embodiments, the structural ceiling may be covered by a further decorative ceiling that is visible during normal use of the elevator car. Such an arrangement is suitable for an emergency access hatch for an elevator car, through which passengers can be rescued in the event of an emergency. The access hatch is arranged to allow people to gain access to the interior of the elevator car from the roof, and vice versa. Whilst this arrangement is useful for emergency evacuation, in some examples the access door assembly may be provided in the floor of an elevator car. In some examples the access door assembly may be provided in a wall panel of an elevator car. Access hatches provided in various places in the elevator car can be useful for maintenance operations, as well as emergency evacuation of the elevator car.

The access door assembly may be retrofitted into a car panel in a manner that means that the car frame is not interfered with. Many elevator cars are designed with modular elevator car panels, and the access door assembly of this disclosure is suitable for easy fitting into elevator cars with, for example, modular-type structural ceilings.

In some examples the perpendicular movement of the access door panel is downwards, and the final open position of the access door panel is underneath the structural ceiling of the elevator car. Such an arrangement is advantageous as it allows for more free space on top of the elevator car, which allows for emergency service personnel to work safely to aid with the evacuation of passengers.

In some examples the access door panel is openable from the outside of the elevator car. Such an arrangement is often required by elevator regulations to prevent unsafe evacuation of passengers. In some examples the access door panel may be openable from inside the elevator car, especially for use by maintenance personnel. The access door panel may be provided with a safety system to prevent unwanted or unsafe opening of the access door panel.

According to a third aspect of this disclosure there is provided an elevator system including the elevator car as disclosed above.

According to a fourth aspect of this disclosure there is provided an elevator access door for use with an elevator car panel; wherein the access door comprises an access door panel for closing an access hatch in an elevator car panel; and a hinge mechanism connected to the access door panel and for connecting the access door panel to an elevator car panel; wherein the hinge mechanism allows the access door panel to move from an initial closed position in an initial plane to a final open position in a final plane substantially parallel to the initial plane; and wherein the hinge mechanism constrains the access door panel when opening to move perpendicular to the initial plane and rotate around an axis perpendicular the initial plane to enable the access door panel to reach a final open position substantially parallel to its initial closed position without substantially overlapping its initial closed position.

### DRAWING DESCRIPTION

FIG. 1 is a schematic illustration of an elevator system that may employ various examples of the present disclosure;

FIG. 2 is a schematic illustration of a structural ceiling of an elevator car with a closed access door assembly showing an example of the present disclosure;

FIG. 3 is a schematic illustration of a structural ceiling of an elevator car with an open access door assembly showing an example of the present disclosure;

FIG. 4 is an illustration of an access door assembly according to an example of the present disclosure.

### DETAILED DESCRIPTION

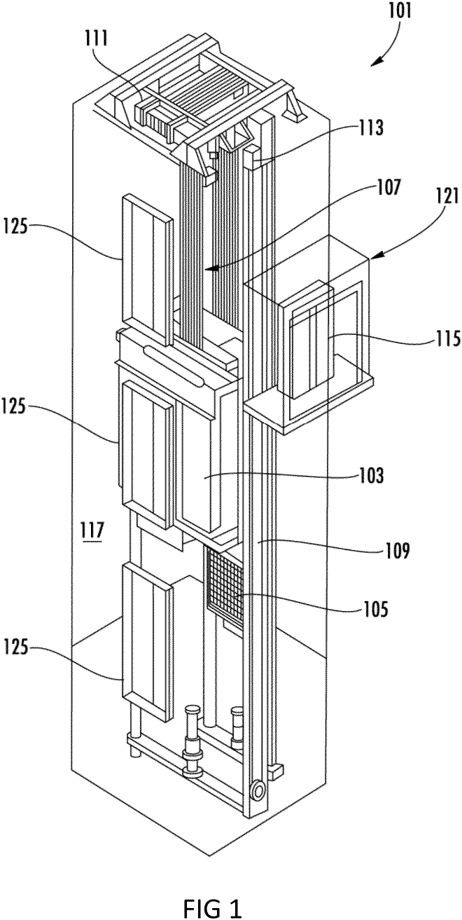

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other examples, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, levelling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one example, the controller may be located remotely or in the cloud.

The machine 111 may include a motor or similar driving mechanism. In accordance with examples of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including a tension member 107, elevator systems that employ other methods and mechanisms of moving an elevator car within an elevator hoistway represent examples of the present disclosure. For example, ropeless elevator systems using a linear motor to impart motion to an elevator car or using a hydraulic drive to impart motion to an elevator car. FIG. 1 is merely a non-limiting example presented for illustrative and explanatory purposes.

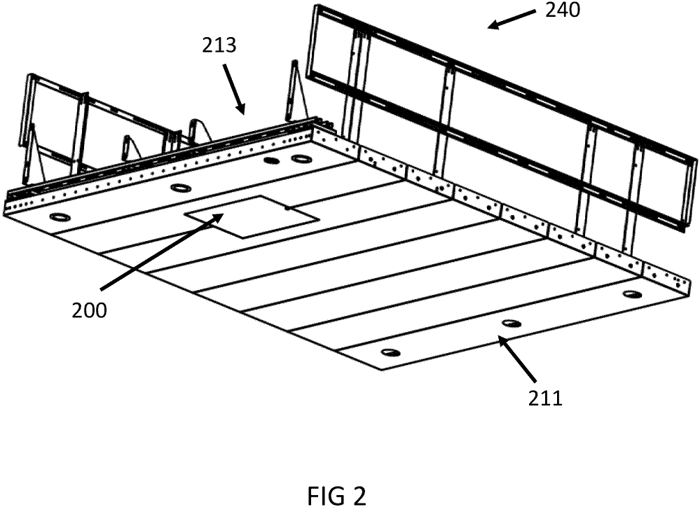

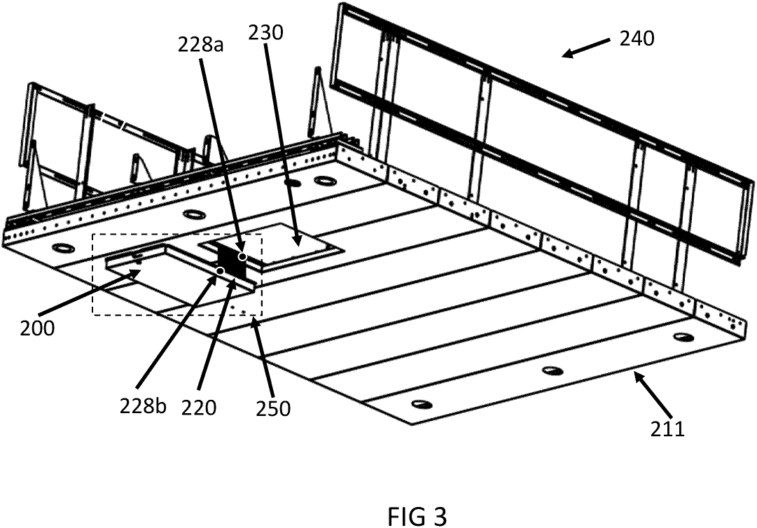

FIG. 2 shows an example of an access door assembly 240 with an access door panel 200 provided in a structural ceiling 211 of an elevator car. The structural ceiling 211 is the one defined by the roof 213 of the elevator car, although a further decorative ceiling (not shown) may be arranged to cover the structural ceiling 211 during normal use of the elevator car. The access door panel 200 is shown in an initial closed position, flush with the panels of the structural ceiling 211 and closing an access hatch 230 (seen in FIG. 3). The access hatch 230 allows people to gain access from the roof 213 to the interior of the elevator car, and vice versa. It will be appreciated that internal elements of the elevator car are not shown in this example.

FIG. 3 shows the example of FIG. 2 with an open access door panel 200 showing the access hatch 230. A hinge mechanism 220 is attached to the structural ceiling 211 via a first fixing point 228a and is attached to the access door panel 200 via a second fixing point 228b. The access door 250 is shown as the combination of the access door panel 200 with the hinge mechanism 220 as described further below. In this example the access door panel 200 is shown in a final open position. The access door panel 200 in its final open position is shown parallel to the structural ceiling 211 and outside the access hatch 230. It will be appreciated that whilst this example shows the access door panel 200 fully parallel to the plane of the structural ceiling 211 and fully out of the way of the access hatch 230, it is possible to achieve the same effect with slight deviations from these parameters, i.e. a small (less than 10° from the parallel plane) inclination of the access door panel 200; or a small overlap of the access door panel 200 and the access hatch 230 where a person can reasonably be expected to still fit though the access hatch 230.

It will be appreciated that the first fixing point 228a, and the second fixing point 228b, are representative of points of fixation only, and that the exact locations of the fixing points 228a, 228b will vary depending on the nature of the hinge mechanism 220 and the structure of both the access door panel 200 and the structural ceiling 211.

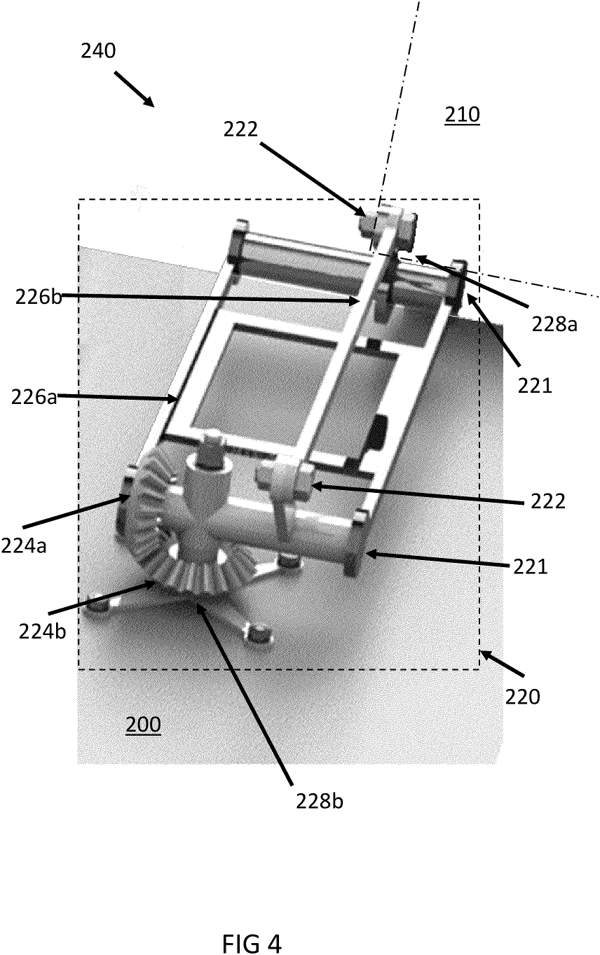

Whilst the examples shown herein describe an access hatch 230 being provided in the structural ceiling 211 of an elevator car, a person skilled in the art will appreciate that access hatches 230 may be provided in any suitable elevator car panel 210, e.g. a side wall panel or a floor panel, as shown generally in FIG. 4. Access doors 250 can therefore be used in any location where an access hatch 230 can be made in an elevator car panel 210. Elevator cars may be designed with the access door 250 in place, or an access door 250 can be retrofitted into an elevator car panel 210. It is possible to install access doors 250 of the present disclosure in modular elevator car panels 210.

Various hinge mechanisms 220 may be employed to allow movement of the access door panel 200 from its initial closed position as shown in FIG. 2, to its final open position as shown in FIG. 3. A movement of the access door panel 200 from the initial closed position in the initial plane to the final open position in a final plane includes a movement of the access door panel 200 perpendicular to the initial plane and a rotation of the access door panel 200 around an axis perpendicular to the initial plane. The hinge mechanism 220 may also allow for movement of the access door panel 200 parallel to the initial plane. An example of a hinge mechanism 220 is described below with reference to FIG. 4. Other suitable mechanism may employ at least one of hydraulic rods and pistons; gearing mechanisms; spring mechanisms, electromagnetic actuators, etc.

FIG. 4 shows an example of a hinge mechanism 220 connecting an access door panel 200 (shown partially) to a representative elevator door panel 210 (shown partially). The hinge mechanism 220 includes a first pair of axes 221 in a first plane; a second pair of axes 222 in a second plane offset from the first plane; a pair of perpendicular axis gears 224a, 224b; a lower cam arm 226a; an upper cam arm 226b; and a pair of fixing points 228a, 228b. The first pair of axes 221 are connected by the lower cam arm 226a, and the second pair of axes 222 are connected by the upper cam arm 226b. The upper and lower cam arms 226a, 226b are connected via both pairs of axes 221, 222. In this example the four axes 221, 222 are parallel to one another. Looking down the axis of the axes 221, 222, the lower cam arm 226a and the upper cam arm 226b form a pivoting parallelogram with the axes 221, 222 forming the four corners of the parallelogram. The two fixing points 228a, 228b are provided at opposite corners of the parallelogram.

In this example the first fixing point 228a attaches the upper cam arm 226b to the elevator car panel 210. The pair of perpendicular axis gears 224a, 224b act to translate a rotation of the one of the first pair of axes 221 to a movement perpendicular to that plane. The first gear 224a is mounted on one of the first pair of axes 221 so its axle lies parallel to the initial plane i.e. parallel the elevator car panel 210 and the access door panel 200 when in the initial closed position. It can be seen how the first gear 224a rotates with the axis 221 and is intermeshed with the second gear 224b that is perpendicular to the first gear 224a. The second gear 224b is mounted with its axle perpendicular to the access door panel 200. The rotation of the second gear 224b acts via the second fixation point 228b to move the access door panel 200. The overall movement of the access door panel 200 provided by the perpendicular axis gears 224a, 224b and the pairs of axes 221, 222, as connected by the lower cam arm 226a and upper cam arm 226b, includes both a perpendicular movement relative to the initial plane (the plane of the elevator car panel 210) and a translation as the second gear 224b turns. The resulting motion of the access door panel 200 is generally helical, e.g. moving down and twisting away from the access hatch 230 to the final position seen in FIG. 3.

When a person wishes to open the access door panel 200, a movement of the access door panel 200 perpendicular to the plane of the elevator car panel 210 will cause rotation about the second pair of axes 222, causing pivoting of the first pair of axes 221, thus rotating the first gear 224a. The movement of the first gear 224a will in turn cause a rotation of the second gear 224b in a plane parallel to the plane of the elevator car panel 210. This moves the access door panel 200 both perpendicular to the plane of the elevator car panel 210 and rotates the access door panel 200 so the entire movement of the hinge mechanism 220 allows the access door panel 200 to be moved away from the access hatch 230 to a final position parallel to the plane of the elevator car panel 210.

It will be appreciated that a gearing ratio can be designed to allow a small perpendicular movement to allow for a large rotation movement of the access door panel 200 away from the access hatch 230. The factors considered in the design of the gearing ratio may include at least one of the depth of the elevator car panel 210; the depth of the access door panel 200; the position of the fixing point 228a on the elevator car panel 210; the position of the fixing 228b on the access door panel 200; the size of the access hatch 230; the size of the access door panel 200 etc. In some examples the gearing ratio is designed to enable a small perpendicular movement to allow for at least a 90 degree rotation of the access door panel 200. Whilst a pair of perpendicular axis gears 224 have been described here, a skilled person will appreciate that any suitable type of gear can be used where rotation on one axis is transferred to rotation on an orthogonal axis i.e. a pair of bevel gears; a worm gear system; or a crossed axis gear system.

Whilst just the simple hinge mechanism 220 has been described here, a skilled person will understand that an access door panel 200 for an elevator car 103 may be of a considerable weight, as such the hinge mechanism 220 may be provided with additional mechanisms to either trigger or aid with the movement of the access door panel 200. In some examples the hinge mechanism may be provided with springs. In some examples the hinge mechanism may be provided with hydraulic assistance. In some examples the hinge mechanism is driven by a motor i.e. an axle on one of the pivot points is provided with a motor.

It will be understood that as the perpendicular movement drives the rotation of the access door panel 200, in the example where the access door panel 200 is provided in a ceiling the weight of the access door panel 200 will help open the access door panel 200, easing the opening of the access door panel 200 in an emergency.

The access door panel 200 described herein may be designed to open into an elevator car 103, or it may be designed to open out of the elevator car 103.

In the example of FIG. 4 the first fixing point 228a attaches the upper cam arm 226b to the elevator car panel 210, however the skilled person will appreciate that there are various places of the structure of an elevator car panel 210, which may be appropriate for the attachment of the hinge mechanism 220. For example, an elevator car panel 210 will be made of both flat panels and structural beams. Therefore, it may be appropriate to attach the hinge mechanism 220 to the elevator car panel 210 at a different point on the hinge mechanism 220 to that here described. The position of the first fixing point 228a may depend on the direction of opening of the access door panel.

It is important to provide safe exit points from an elevator car in case of an emergency, especially in the ceiling of an elevator car. Such exits need to be provided in relatively small spaces without disrupting either the space inside the car or the space outside the elevator car. A solution like the one provided here allows for both easy access and an access door panel 200 which does not interfere with the required spaces.

In some examples the access door panel 200 is openable from the outside of the elevator car 103 i.e. by emergency service workers on the ceiling of the elevator car 103. In some examples the access door panel 200 is openable from the inside of the elevator car. In further examples the access door panel 200 is openable from both the inside and the outside of the elevator car. In some examples the access door panel is opened remotely i.e. when the hinge mechanism 220 is driven.

Whilst the access door panel 200 is ideally suited for use as an emergency access door panel in a ceiling, in some examples the access door panel 200 may be employed in an elevator car 103 to provided easy access between the elevator car 103 and hoistway 117 for a maintenance worker (see FIG. 1). For example, an access door panel 200 provided in the floor of the elevator car 103 may provide access to the hoistway pit. In another example the access door panel 200 may provide access to the side of the hoistway 117 for maintenance operations.

It will be appreciated by those skilled in the art that the disclosure has been illustrated by describing one or more specific aspects thereof but is not limited to these aspects; many variations and modifications are possible, within the scope of the accompanying claims.

1. An access door assembly (240) for an elevator car (103), the access door assembly (240) comprising:
an elevator car panel (210, 211) comprising an access hatch (230);
an access door panel (200) arranged to close the access hatch (230); and
a hinge mechanism (220) connecting the access door panel (200) to the elevator car panel (210, 211);
wherein the hinge mechanism (220) allows the access door panel (200) to move from an initial closed position in an initial plane to a final open position in a final plane substantially parallel to the initial plane;
wherein the initial plane is the plane of the elevator car panel (210, 211); and
wherein the hinge mechanism (220) constrains the access door panel (200) when opening to move perpendicular to the initial plane of the elevator car panel (210, 211) and to rotate around an axis perpendicular to the initial plane of the elevator car panel (210, 211), to enable the access door panel (200) to reach a final open position in the final plane substantially parallel to the elevator car panel (210, 211) and substantially outside the access hatch (230).

2. The access door assembly (240) according to claim 1, wherein the hinge mechanism (220) constrains the access door panel (200) when opening to move along a helical path from the initial closed position to the final open position.

3. The access door assembly (240) according to claim 1, wherein the hinge mechanism (220) is arranged to convert movement of the access door panel (200) perpendicular to the initial plane of the elevator car panel (210, 211) into rotational movement around the axis perpendicular to the initial plane of the elevator car panel (210, 211).

4. The access door assembly (240) according to claim 1, wherein the hinge mechanism (220) comprises a mechanical linkage including a first gear (224a) indirectly mounted to the elevator car panel (210, 211) and a second gear (224b) mounted to the access door panel (200).

5. The access door assembly (240) according to claim 4, wherein the first gear (224a) is mounted on a first axle parallel to the elevator car panel (210, 211), the second gear (224b) is mounted on a second axle perpendicular to the access door panel (200), and the first and second gears (224a, 224b) intermesh to rotate the access door panel (200) around the axis perpendicular to the initial plane of the elevator car panel (210, 211) when the access door panel (200) is moved perpendicular to the initial plane of the elevator car panel (210, 211).

6. The access door assembly (240) according to claim 1, wherein the hinge mechanism (220) constrains the access door panel (200) when opening to also move parallel to the initial plane of the elevator car panel (210, 211).

7. The access door assembly (240) according to claim 6, wherein the hinge mechanism (220) comprises:
two pairs of axes (221, 222) parallel to one another;
an upper cam arm (226a) and a lower cam arm (226b) which connect the two pairs of axes (221, 222) to form a pivoting parallelogram when looking along the two pairs of axes (221, 222); and
a first gear (224a) and a second gear (224b) having perpendicular axles; wherein the first gear (224a) is mounted on one of the first pair of axes (221) so its axle lies parallel to the initial plane and the second gear (224b) is mounted on the access door panel (200) with its axle perpendicular to the access door panel (200);
wherein a perpendicular movement of the access door panel (200) causes movement of the access door panel (200) parallel to the elevator car panel (210, 211);
the combination of the perpendicular and parallel movements cause rotation about the two pairs of axes (221, 222); and
wherein the rotation about the two pairs of axes (221, 222) rotates the first gear (224a), the first gear (224a) is intermeshed with the second gear (224b), and the access door panel (200) rotates with the second gear (224b).

8. The access door assembly (240) according to claim 7, wherein at least two axes of the two pairs of axes (221, 222) are fixed relative to the elevator car panel (210, 211).

9. The access door assembly (240) according to claim 1, wherein the hinge mechanism (220) allows the access door panel (200) to rotate by at least 90 degrees around the axis perpendicular to the initial plane of the elevator car panel (210, 211).

10. An elevator car (103) comprising the access door assembly (240) according to claim 1.

11. The elevator car (103) according to claim 10, wherein the elevator car panel (210) is part of a structural ceiling (211) of the elevator car (103).

12. The elevator car (103) according to claim 11, wherein the perpendicular movement of the access door panel (200) is downwards, and the final open position of the access door panel (200) is underneath the structural ceiling (211) of the elevator car (103).

13. The elevator car (103) according to claim 10, wherein the access door panel (200) is openable from the outside of the elevator car (103).

14. An elevator system including the elevator car (103) according to claim 10.

15. An access door (250) for use with an elevator car panel (210);
wherein the access door (250) comprises an access door panel (200) for closing an access hatch (230) in the elevator car panel (210, 211); and
a hinge mechanism (220) connected to the access door panel (200) and for connecting the access door panel (200) to the elevator car panel (210, 211);
wherein the hinge mechanism (220) allows the access door panel (200) to move from an initial closed position in an initial plane to a final open position in a final plane substantially parallel to the initial plane; and
wherein the hinge mechanism (220) constrains the access door panel (200) when opening to move perpendicular to the initial plane and rotate around an axis perpendicular the initial plane to enable the access door panel (200) to reach the final open position substantially parallel to its initial closed position without substantially overlapping its initial closed position.

16. The access door assembly (240) according to claim 1, wherein the axis perpendicular to the initial plane of the elevator car panel is in a fixed position.
